(19) United States
(12) Patent Application Publication
(10) Pub. No.: US 2002/0168080 A1
(43) Pub. Date: Nov. 14, 2002

(54) Inner insulation for electroacoustic capsules

(76) Inventor: Gino Pavlovic, Wien (AT)

Correspondence Address: FRIEDRICH KUEFFNER, PATENT AND TRADEMARK ATTORNEY, SUITE 910, 317 MADISON AVENUE, NEW YORK, NY, 10017, US

(21) Appl. No.: 10/146,723

(22) Filed: May 14, 2002

(30) Foreign Application Priority Data
May 14, 2001 (AT) A 766/2001

(51) Int. Cl. H04R 9/08; H04R 11/04; H04R 17/02; H04R 19/04; H04R 21/02

(52) U.S. Cl. 381/369

(57) ABSTRACT

An electroacoustic transducer, operating electrostatically and functioning as a sound receiver, is configured to be inserted in a microphone capsule. The capsule housing has an inner side and an outer side, wherein at least the inner side of the capsule housing has a Teflon® coating. The capsule housing has an end face forming the electrode of the transducer. The capsule housing is manufactured by a cold forming method from an aluminum sheet, coated at least on one side with Teflon®.

### BACKGROUND OF THE INVENTION

1. Field of the Invention

The invention relates to electroacoustic transducers functioning electrostatically which operate as sound receivers and are arranged in a microphone capsule Such transducers have, independent of their physical operating mode, a diaphragm which is exposed to the field of sound and excited by it to perform vibrations.

2. Description of the Related Art

The subject matter of the present invention is thus an electrostatic microphone. The electrodes of the electrostatic transducer are an elastic, taut diaphragm and a stationary electrode which is usually referred to simply as electrode. Both together form a capacitor whose electrical capacitance changes as a result of pressure fluctuations of the field of sound. Since an electric field is built up between the electrodes of the electrostatic transducer, it is possible to convert the capacitance changes of the transducer by means of an amplifier arranged downstream into electrical voltage changes.

Electrostatic capsules can be divided into two groups with respect to the type of application of the electrical field between its electrodes:

Electrostatic capsules in which the charges which generate the electrical field are applied by means of an externally supplied voltage (polarization voltage): capacitor capsules.

Electrostatic capsules in which the electrical charge is “frozen” on the electrode or diaphragm so that in this way an externally applied voltage is obsolete: electret capsule.

Microphone capsules which are used as electrostatic transducers for building microphones can be divided with respect to construction measures into capsule housing and capsule interior The capsule housing can be manufactured either of an electrically insulating material (plastic material) or an electrically conducting material (metal). The task of the capsule housing is, on the one hand, to mechanically combine and protect the interior components as a unit and, on the other hand, to keep away electromagnetic disturbances from the interior of the capsule. Each of the two material groups has its advantages and disadvantages.

The advantages of a capsule housing made of plastic material reside in a relatively simple manufacture which enables even very complex embodiment variants by using a plastic injection molding tool that is manufactured once. The disadvantage resides in the inability of plastic material to shield against electromagnetic interference. For this reason, microphone capsules of plastic material are mounted only in a microphone housing or device of metal wherein the protection against electromagnetic interference is then taken over by the device itself.

The advantage of a capsule housing made of metal relative to a capsule housing made of plastic material is its excellent shielding action. However, with regard to its electrical insulation properties in the interior of the microphone capsule and also the resulting industrial capsule manufacture, several disadvantages result. Since the microphone capsule housing made of metal in this size (d=6-30 mm) and wall thickness (0.1-0.5 mm) cannot be produced by a metal casting method, a material removing method of manufacture (time-consuming) or manufacture by a deep-drawing method is usually employed.

Since the microphone capsule increasingly is mounted in telecommunication devices (mobile and wireless telephones) with plastic housings, the type of embodiment of the microphone capsule housing is of essential importance for the electromagnetic compatibility of the device. For this reason, such devices which have no metal housing can be used only in connection with microphone capsules with a metal housing. In this context, the electrical conductivity of the capsule housing is desirable but the electrical conductivity on its inner side is again a great disadvantage. The disadvantage resides in the fact that the microphone capsule is embodied as a voltage source which depends on the sound pressure and has a very high inner (electrical) resistance. For this reason, all inner components of the microphone capsule must be very well insulated electrically from one another and from the inner wall of the capsule housing.

In order to achieve this, insulation cups or insulation strips of Teflon are provided between the interior of the capsule and the capsule housing which are said to provide excellent insulation stretches under all climatic conditions. It is not necessary to emphasize the fact that such components increase the cost of such a microphone capsule and that they frequently are a source for failure.

### SUMMARY OF THE INVENTION

It is an object of the present invention to improve microphone capsule housings made of metal so that they no longer have the described disadvantages but can be produced inexpensively and reliably.

In accordance with the present invention, this is achieved in that for the manufacture of the microphone capsule housing a sheet metal is used as a starting material which is coated at least on one side with Teflon®. The (or the one) side of the sheet metal which is coated is positioned within the deep-drawing tool such that it forms the interior of the capsule housing. In this way it is possible to eliminate the above described insulation cups or insulation strips and to obtain a very reliable electrical insulation without having to use a separate component and without this requiring a separate manufacturing step.

In one embodiment of the invention, the end face of the microphone capsule cup according to the invention is employed as a rigid capsule electrode which results in a further simplification, miniaturization, and cost reduction of the microphone.

As already mentioned, the electrostatic transducers have two electrodes. The movable one is the diaphragm and the stationary (immobile) one is usually simply referred to as electrode and is usually positioned within the interior of the microphone capsule. The configuration of the invention now provides that the end face, also referred to as the front, which results during deep-drawing of the capsule and whose outer side is comprised of metal and whose inner side is comprised of the Teflon® coating, is to be used as an electrode.

For this purpose, it is only necessary to provide this front with the conventional penetrations or cutouts in order to allow passage of the sound and to apply the conventional charges to the Teflon® layer or coating, which is possible in a way known in the prior art. It is also possible to manufacture, in particular, miniaturized capsules with this inventive variant in which the possibility of eliminating a separate component—the electrode—provides important savings with regard to space and cost.

### BRIEF DESCRIPTION OF THE DRAWING

In the drawing:

FIG. 1 shows an electroacoustic transducer according to the prior art;

FIG. 2 shows the electroacoustic transducer according to the invention; and

FIG. 3 shows an especially preferred embodiment of an electroacoustic transducer according to the invention.

### DESCRIPTION OF THE PREFERRED EMBODIMENTS

In all illustrations, contacts or cables have been eliminated for simplifying the drawings. The same holds true for possibly present fastening means for the capsule within the device.

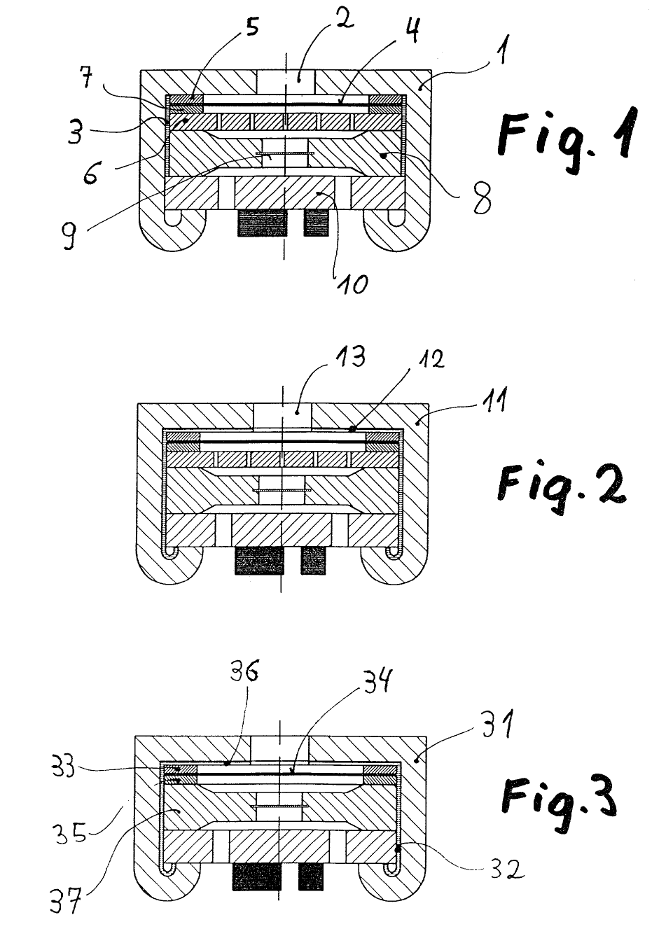

FIG. 1 shows a capsule of an electroacoustic transducer, operating according to the electrostatic principle, with a metal housing according to the prior art.

The capsule housing 1 is comprised conventionally of sheet aluminum and is produced by means of a deep-drawing process. It has a sound entry opening 2 which conventionally has been stamped out in the deep-drawing step so that the sound can impact unimpededly and directly on the diaphragm 4. The capsule housing 1 is electrically insulated by means of a Teflon® ring or a Teflon® strip 3 from the components in the interior of the capsule housing. This prevents that the individual components of the electrostatic transducer could reach the same potential as the capsule housing by contact with the capsule housing 1.

The diaphragm 4 is glued onto a diaphragm ring 5; a spacing between the diaphragm 4 and the (rigid or immobile) electrode 6 is ensured by means of a spacer ring 7. The electrode 6, like the other components arranged downstream in the axial direction, has openings in order to enable also on this side access of the sound to the diaphragm 4 and, in this way, to achieve a correct tuning of the frequency characteristic of the capsule as a whole, on the one hand, and the provided tuning with regard to pick-up characteristic, on the other hand.

Behind (always viewed in the main direction of sound travel) the electrode 6, a so-called acoustic friction pill 8 is provided. It is produced of plastic material by an injection molding process and has at least one opening which is closed by a porous material 9 or covered by it. Usually, this material is comprised of an open-pore foamed polyurethane. As a result of the adjustment of its geometric dimensions and the magnitude of the air permeability, the above mentioned goals are achieved.

The capsule is closed at its lower side by a printed circuit 10 with electrical components. The printed circuit supports a high-resistance circuit for converting the signals of the high-resistance electrode pair. Moreover, the print 10 also has a sound-permeable opening as mentioned above.

FIG. 2 shows a capsule according to the invention. The difference between the present invention and the prior art, illustrated in FIG. 1, resides in the elimination of the Teflon® ring. This is enabled in that the capsule housing 11 according to the invention is coated or covered with a Teflon® layer or coating 12.

Sheet metal that is coated with a thin Teflon® layer (10 μm to 50 μm thickness) is commercially available worldwide, and its procurement is no problem for a person skilled in the art. A possible source is the company Sumitomo. This composite material is used in the prior art for manufacturing the electrode of electrostatic microphones or speakers wherein matching openings are stamped into this raw material by the respective device manufacturer and wherein the outer contour of the electrode is also provided by a stamping process. In the prior art, such a material is used, for example, to form an electrode 6 illustrated in FIG. 1.

According to the invention, this material is now shaped by a deep-drawing process to adopt the shape of the capsule housing 11 wherein in the illustrated case the one-sided coating of the Teflon® material 12 is positioned so as be facing the interior of the capsule. For this purpose, it is only necessary to position the sheet metal which is coated on one side “correctly” into the deep-drawing mold. In the case of using a two-sided coated sheet metal, no attention must be paid, of course, to the orientation of the sheet.

In most cases already before deep drawing, but also possibly after deep-drawing, the sound opening 13 is stamped out. In most cases, the sound opening 13 is provided by several small openings in order to be able to also obtain an electromagnetic shielding from the forward side; electromagnetic shielding decreases rapidly with increasing holes size but decreases only slowly with increasing number of holes.

The remaining configuration of a microphone according to the invention corresponds to that of the microphone illustrated in FIG. 1, with the exception that the expensive Teflon® strips or Teflon® cups are not required which results in a significant cost reduction Moreover, the elimination of the Teflon® strip, which during the course of automatic manufacture and high cycle times must remain in a form so that it can be manipulated (shape-stable) and must therefore have a significant thickness, enables a significantly smaller configuration of the entire housing of the capsule in comparison to the size possible according to the prior art.

A preferred embodiment of the invention, which provides significant additional advantages, is illustrated in FIG. 3. This further embodiment of the invention enables to replace the electrode 6 (FIG. 1) with the inner side of the capsule front 36. The capsule housing 31, as already mentioned above, is coated with a Teflon® layer 32 and is thus capable of taking on the role of the electrode.

The further capsule configuration is as follows. A spacer ring 33 positions the diaphragm 34, which, as in the prior art, is glued to the diaphragm ring 35, at a spacing from the inner side of the capsule front which in this embodiment functions as the electrode The remaining configuration corresponds to that of FIG. 1.

In this preferred variant of the invention, it is thus possible not only to eliminate the Teflon® strip 3 of FIG. 1 but also the electrode (as an individual component) so that the capsule can be produced more cheaply and, relative to the axial direction, with a significantly reduced height. With a corresponding configuration of the friction pill 37 it is also possible to eliminate the diaphragm ring 35, if desired. In this connection, one must take into consideration that the axial extension of the capsule according to the prior art, as illustrated in FIG. 1, has been reduced for mobile telephones to a range of 6-7 mm so that, therefore, the possibility of eliminating a component which extends in the axial direction provides an enormous technical advance with great business-related consequences, not to mention the cost reduction as a result of elimination of the part and simplification of assembly.

As can be taken clearly from the aforementioned discussion, the illustrations of the capsules are, of course, not to scale but purely schematic; the spacing between the diaphragm and the surface of the electrode facing it is only a few hundredths of a millimeter, and the thickness of the other components is similarly minimal as can be taken from the above description.

The invention is not limited to the illustrated embodiment but can be modified and changed in many ways. For example, it is possible to manufacture the capsule housing 11, 31 of two-sided coated sheet aluminum (or of other sheet metal or electrically contacting material) when, for example, the capsule exterior is to be designed to be electrically insulated from the surroundings. Also, the use of other metal capable of being deep-drawn, instead of aluminum is conceivable, even through the use of aluminum is preferred for cost considerations and technological reasons (best suited material for deep-drawing).

In certain situations, it is not required to provide a friction pill as a separate component; in particular, when the capsule housing is mounted at a location within the device where the capsule holder can take over tasks of the acoustic friction pill, the friction pill can be eliminated. Similarly, the task of the printed circuit 10 with electrical components can be taken over by a printed circuit of the device on which the capsule is essentially directly mounted. These simplifications or combinatory possibilities, in particular, in combination with the surroundings of the respective microphone capsule, can be easily decided and carried out by a person skilled in the art in knowledge of the present invention.

The invention can be used for electret capsules as well as capacitor capsules; a constructive difference is not present: the only difference is that in the first situation the charges are applied permanently on the electrode or diaphragm and in the second situation are produced during use of the capsule by means of an external voltage source.

While specific embodiments of the invention have been shown and described in detail to illustrate the inventive principles, it will be understood that the invention may be embodied otherwise without departing from such principles.

What is claimed is:

1. An electroacoustic transducer, operating electrostatically and functioning as a sound receiver and configured to be inserted into a microphone capsule, the transducer comprising:
a capsule housing having an inner side and an outer side, wherein at least the inner side of the capsule housing has a Teflon® coating.

2. The transducer according to claim 1, wherein the capsule housing has an end face and wherein the end face forms an electrode of the transducer.

3. The transducer according to claim 1, wherein the capsule housing is manufactured by a cold forming method from an aluminum sheet, coated at least on one side with Teflon®.

4. The transducer according to claim 1, wherein the Teflon® coating has a thickness of 10 to 50 micrometer.
